(19) United States
(12) Patent Application Publication
(10) Pub. No.: US 2003/0155417 A1
(43) Pub. Date: Aug. 21, 2003

(54) Content vending machine using IEEE 1394

(75) Inventor: Bruce Alan Fairman, Woodside, CA (US)

Correspondence Address: Jonathan O. Owens, HAVERSTOCK & OWENS LLP, 162 N. Wolfe Road, Sunnyvale, CA, 94086, US

(73) Assignee: Sony Corporation

(21) Appl. No.: 10/078,562

(22) Filed: Feb. 15, 2002

(51) Int. Cl. G06F 7/08

(52) U.S. Cl. 235/381

(57) ABSTRACT

A multimedia content vending machine enables a user to download multimedia data files from a locally stored storage medium within the vending machine to an externally connected media storage device. The multimedia content vending machine includes a user interface, a means for accepting payment, an interface for coupling with the external media storage device, and a network interface for coupling to a communications network. Preferably, each multimedia data file is offered on a rental basis. Rental payment is received via the means for accepting payment. The multimedia data file to be rented is downloaded with a corresponding expiration time. The external media storage device is capable of invalidating the downloaded multimedia data file once the expiration time has elapsed. Preferably, the multimedia content vending machine and the external media storage device are coupled via an IEEE 1394-2000 serial bus.

### FIELD OF THE INVENTION

The present invention relates to the field of writing data to media storage devices. More particularly, the present invention relates to the field of writing data to media storage devices from a content vending machine.

### BACKGROUND OF THE INVENTION

Traditionally, people have been able to rent VHS videos and view the videos using a conventional VCR. Unfortunately, renting videos is often inconvenient, expensive if the video is not returned on time, and lacking in quality due to the nature of VHS tapes. CD-ROM technology, and more recently DVD technology, provides an increased level of video quality due to digitally stored content. With digital content comes improved quality, however the inconvenience and possible additional late fees associated with renting still exists.

Broadcast services provided by satellite and cable service providers continue to expand as users turn to the convenience of in-house services provided over these broadcast mediums. Pay-per-view movies can be ordered using a cable set-top box or satellite receiver and viewed on a televison. Unfortunately, pay-per-view movies are only available at predetermined times and users can not pause, rewind, or fast forward as desired.

Demand for portable digital content is also on the rise. With the proliferation of lap top computers, users continue to look for means of accessing and obtaining digital content while on the go. Internet cafes, pay phones with computer connectivity, and wireless service connectivity provides access to downloadable data. CD-ROM and DVD diskettes provide portability of previously obtained digital content. Such CD-ROMs and DVDs are sold, or often rented, at high traffic areas like airports, train stations, or shopping malls where interested users can obtain the portable diskettes at either traditionally run stores or automated kiosks. Automated kiosks, or vending machines, also provide users the convenience of renting VHS movies. While renting from vending machines may be convenient, the problem of having to return the hard copy rented still exists.

As demand for digital content increases, so does the availability of mediums capable of transmitting the digital content. Cable service providers are offering digital cable, satellite service providers are offering digital satellite system (DSS), and television manufacturers are providing high definition television (HDTV). The internet has also provided a medium that enables users to receive audio and video content. Regardless of the transmission medium, the audio and video data streams representative of the digital content downloaded over the Internet can be stored on a conventional hard disk drive.

A traditional hard disk drive records data and plays it back according to commands received from an external controller using a protocol such as the serial bus protocol (SBP). The external controller provides command data structures to the hard disk drive which informs the hard disk drive where on the media the data is to be written, in the case of a write application, or read from, in the case of a read operation.

Use of a media storage device, such as a hard disk drive, for storing streams of audio and video data is taught in U.S. patent application Ser. No. 09/022,926, filed on Feb. 12, 1998 issued as U.S. Pat. No. 6,292,844 on Sep. 18, 2001, and entitled “MEDIA STORAGE DEVICE WITH EMBEDDED DATA FILTER FOR DYNAMICALLY PROCESSING DATA DURING READ AND WRITE OPERATIONS,” which is hereby incorporated by reference. Such a media storage device is referred to as an audio/video hard disk drive, or AVHDD.

Once received by the hard disk drive, the digital content can be displayed by any number of appropriately connected devices. The IEEE 1394-2000 serial bus provides one such connection.

The IEEE standard, “IEEE 1394-2000 Standard For A High Performance Serial Bus,” Draft ratified in 2000, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. The IEEE 1394-2000 standard bus architecture provides up to sixty-four (64) channels for isochronous data transfer between applications. A six bit channel number is broadcast with the data to ensure reception by the appropriate application. This allows multiple applications to simultaneously transmit isochronous data across the bus structure. Asynchronous transfers are traditional data transfer operations which take place as soon as possible and transfer an amount of data from a source to a destination.

The IEEE 1394-2000 standard provides a high-speed serial bus for interconnecting digital devices thereby providing a universal I/O connection. The IEEE 1394-2000 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394-2000 standard is very thin in size compared to other bulkier cables used to connect such devices. Devices can be added and removed from an IEEE 1394-2000 bus while the bus is active. If a device is so added or removed the bus will then automatically reconfigure itself for transmitting data between the then existing nodes. A node is considered a logical entity with a unique identification number on the bus structure. Each node provides an identification ROM, a standardized set of control registers and its own address space.

The IEEE 1394-2000 standard defines a protocol as illustrated in FIG. 1. This protocol includes a serial bus management block 10 coupled to a transaction layer 12, a link layer 14 and a physical layer 16. The physical layer 16 provides the electrical and mechanical connection between a device or application and the IEEE 1394-2000 cable. The physical layer 16 also provides arbitration to ensure that all devices coupled to the IEEE 1394-2000 bus have access to the bus as well as actual data transmission and reception. The link layer 14 provides data packet delivery service for both asynchronous and isochronous data packet transport. This supports both asynchronous data transport, using an acknowledgment protocol, and isochronous data transport, providing real-time guaranteed bandwidth protocol for just-in-time data delivery. The transaction layer 12 supports the commands necessary to complete asynchronous data transfers, including read, write and lock. The serial bus management block 10 contains an isochronous resource manager for managing isochronous data transfers. The serial bus management block 10 also provides overall configuration control of the serial bus in the form of optimizing arbitration timing, guarantee of adequate electrical power for all devices on the bus, assignment of the cycle master, assignment of isochronous channel and bandwidth resources and basic notification of errors.

The IEEE 1394-2000 cable environment is a network of nodes connected by point-to-point links, including a port on each node's physical connection and the cable between them. The physical topology for the cable environment of an IEEE 1394-2000 serial bus is a non-cyclic network of multiple ports, with finite branches. The primary restriction on the cable environment is that nodes must be connected together without forming any closed loops.

The IEEE 1394-2000 cable connects ports together on different nodes. Each port includes terminators, transceivers and simple logic. A node can have multiple ports at its physical connection. The cable and ports act as bus repeaters between the nodes to simulate a single logical bus.

### SUMMARY OF THE INVENTION

A multimedia content vending machine enables a user to download multimedia data files from a locally stored storage medium within the vending machine to an externally connected media storage device. The multimedia content vending machine includes a user interface, a means for accepting payment, an interface for coupling with the external media storage device, and a network interface for coupling to a communications network. Preferably, each multimedia data file is offered on a rental basis. Rental payment is received via the means for accepting payment. The multimedia data file to be rented is downloaded with a corresponding expiration time. The external media storage device is capable of invalidating the downloaded multimedia data file once the expiration time has elapsed. Preferably, the multimedia content vending machine and the external media storage device are coupled via an IEEE 1394-2000 serial bus.

According to an aspect of the present invention, a multimedia content vending machine includes a processor, a storage medium for storing a plurality of multimedia data files, a user interface for displaying a menu of downloadable selections corresponding to the plurality of multimedia data files stored in the storage medium, identifying a user selection from the menu, and notifying the processor of the user selection, a payment interface for accepting payment and for notifying the processor when payment is made, and a download interface for coupling with an external media storage device, wherein the processor instructs the storage medium to transmit the stored multimedia data file corresponding to the user selection upon receiving payment notification from the payment interface, and the download interface receives the transmitted multimedia data file from the storage medium and transmits the multimedia data file to the external media storage device. The multimedia content vending machine further includes a network interface for coupling with a communications network. The payment interface is a credit card reader for reading credit cards and receiving payment authorization associated with the read credit card. The credit card reader also accepts debit cards. Credit card payment authorization is obtained via communication over the communications network. One or more of the plurality of stored multimedia data files are replaced by multimedia data files downloaded from the communications network via the network interface. The communications network is a selective one of a public switched telephone network or a dedicated data network. The user interface is a monitor including a touch screen for receiving user input. The download interface includes an interface circuit that substantially complies with an IEEE 1394-2000 standard. The multimedia data file is transmitted from the download interface to the external media storage device over a serial bus that substantially complies with the IEEE 1394-2000 standard. The stored multimedia data file is transmitted from the storage medium to the download interface over a serial bus that substantially complies with the IEEE 1394-2000 standard. The storage medium includes a plurality of media storage devices. One or more of the plurality of media storage devices are replaced in order to change the multimedia data files available for downloadable selection. The plurality of multimedia data files stored in the storage medium are encrypted. The multimedia data file received by the external media storage device is encrypted and the external media storage device decrypts the multimedia data file for playback. The downloaded encrypted multimedia data file includes a time restriction that limits playback of the multimedia data file by the external media storage device to a specified time frame.

According to another aspect of the present invention, a multimedia content vending machine includes a processor, a user interface for displaying a menu of downloadable selections corresponding to a plurality of multimedia data files stored at a remote location, identifying a user selection from the menu, and notifying the processor of the user selection, a payment interface for accepting payment and for notifying the processor when payment is made, a download interface for coupling with an external media storage device, and a network interface for coupling with a communications network, wherein the remote location storing the plurality of multimedia data files is coupled to the network interface via the communications network, wherein upon receiving payment notification from the payment interface, the processor instructs the remote location to transmit the stored multimedia data file corresponding to the user selection, the network interface receives the transmitted multimedia data file and transmits the multimedia data file to the download interface, and the download interface receives the transmitted multimedia data file from the network interface and transmits the multimedia data file to the external media storage device. The payment interface is a credit card reader for reading credit cards and receiving payment authorization associated with the read credit card. The credit card reader also accepts debit cards. Credit card payment authorization is obtained via communication over the communications network. The communications network is a selective one of a public switched telephone network or a dedicated data network. The user interface is a monitor including a touch screen for receiving user input. The download interface includes an interface circuit that substantially complies with an IEEE 1394-2000 standard. The multimedia data file is transmitted from the download interface to the external media storage device over a serial bus that substantially complies with the IEEE 1394-2000 standard. The multimedia data file received by the external media storage device is encrypted and the external media storage device decrypts the multimedia data file for playback. The downloaded encrypted multimedia data file includes a time restriction that limits playback of the multimedia data file by the external media storage device to a specified time frame.

According to yet another aspect of the present invention, a multimedia content vending machine includes a processor, a storage medium for storing a plurality of encrypted multimedia data files, a user interface for displaying a menu of downloadable selections corresponding to the plurality of multimedia data files stored in the storage medium, identifying a user selection from the menu, and notifying the processor of the user selection, a payment interface for accepting payment and for notifying the processor when payment is made, and a download interface for coupling with an external media storage device, wherein upon receiving payment notification from the payment interface, the processor instructs the storage medium to further encrypt the stored multimedia data file corresponding to the user selection with a time key for restricting playback to within a predetermined time frame and to transmit the encrypted multimedia data file to the download interface, and the download interface receives the transmitted encrypted multimedia data file from the storage medium and transmits the encrypted multimedia data file to the external media storage device. The multimedia content vending machine also includes a network interface for coupling with a communications network. The payment interface is a credit card reader for reading credit cards and receiving payment authorization associated with the read credit card. The credit card reader also accepts debit cards. Credit card payment authorization is obtained via communication over the communications network. One or more of the plurality of stored multimedia data files are replaced by multimedia data files downloaded from the communications network via the network interface. The communications network is a selective one of a public switched telephone network or a dedicated data network. The user interface is a monitor including a touch screen for receiving user input. The download interface includes an interface circuit that substantially complies with an IEEE 1394-2000 standard. The multimedia data file is transmitted from the download interface to the external media storage device over a serial bus that substantially complies with the IEEE 1394-2000 standard. The stored multimedia data file is transmitted from the storage medium to the download interface over a serial bus that substantially complies with the IEEE 1394-2000 standard. The storage medium includes a plurality of media storage devices. One or more of the plurality of media storage devices are replaced in order to change the multimedia data files available for downloadable selection.

According to another aspect of the present invention, a multimedia content vending system includes a media storage device for storing multimedia content, and a multimedia content vending machine including a processor, a storage medium for storing a plurality of multimedia data files, a user interface for displaying a menu of downloadable selections corresponding to the plurality of multimedia data files stored in the storage medium, identifying a user selection from the menu, and notifying the processor of the user selection, a payment interface for accepting payment and for notifying the processor when payment is made, and a download interface for coupling with the media storage device, wherein upon receiving payment notification from the payment interface, the processor instructs the storage medium to transmit the stored multimedia data file corresponding to the user selection to the download interface, and the download interface receives the transmitted multimedia data file from the storage medium and transmits the multimedia data file to the media storage device. The multimedia content vending system also includes a network interface for coupling with a communications network. The payment interface is a credit card reader for reading credit cards and receiving payment authorization associated with the read credit card. The credit card reader also accepts debit cards. Credit card payment authorization is obtained via communication over the communications network. One or more of the plurality of stored multimedia data files are replaced by multimedia data files downloaded from the communications network via the network interface. The communications network is a selective one of a public switched telephone network or a dedicated data network. The user interface is a monitor including a touch screen for receiving user input. The download interface includes an interface circuit that substantially complies with an IEEE 1394-2000 standard. The multimedia data file is transmitted from the download interface to the external media storage device over a serial bus that substantially complies with the IEEE 1394-2000 standard. The stored multimedia data file is transmitted from the storage medium to the download interface over a serial bus that substantially complies with the IEEE 1394-2000 standard. The storage medium includes a plurality of media storage devices. One or more of the plurality of media storage devices are replaced in order to change the multimedia data files available for downloadable selection. The plurality of multimedia data files stored in the storage medium are encrypted. The multimedia data file received by the external media storage device is encrypted and the external media storage device decrypts the multimedia data file for playback. The downloaded encrypted multimedia data file includes a time restriction that limits playback of the multimedia data file by the external media storage device to a specified time frame.

### BRIEF DESCRIPTION OF THE DRAWINGS

FIG. 1 illustrates a protocol defined by the IEEE 1394-2000 standard.

FIG. 2 illustrates a multimedia content vending machine of the present invention.

FIG. 3 illustrates a block diagram of the internal components of the multimedia content vending machine according to the preferred embodiment of the present invention.

FIG. 4 illustrates a block diagram of a media storage device according to the preferred embodiment of the present invention.

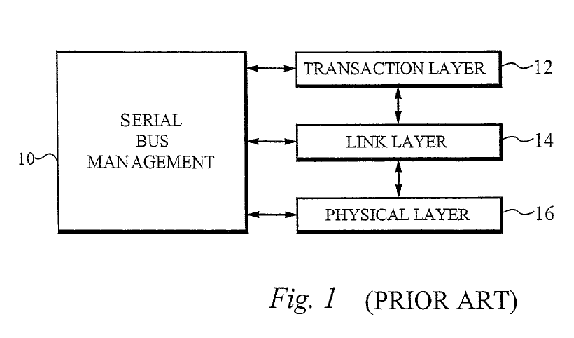

### DETAILED DESCRIPTION OF THE PREFERRED EMBODIMENT

A multimedia content vending machine of the present invention enables a user to access multimedia data files stored on the vending machine for download to an externally connected media storage device. Alternatively, the vending machine is a processing center where a user can access multimedia data files stored at a remote location and download a remotely stored multimedia data file onto an externally connected media storage device via the vending machine. Preferably, the user downloads the multimedia data file on a rental basis, and the multimedia data file is available to be viewed for a predetermined time frame. After the predetermined time frame, the multimedia data file is invalidated or deleted by the media storage device onto which the multimedia data file was downloaded.

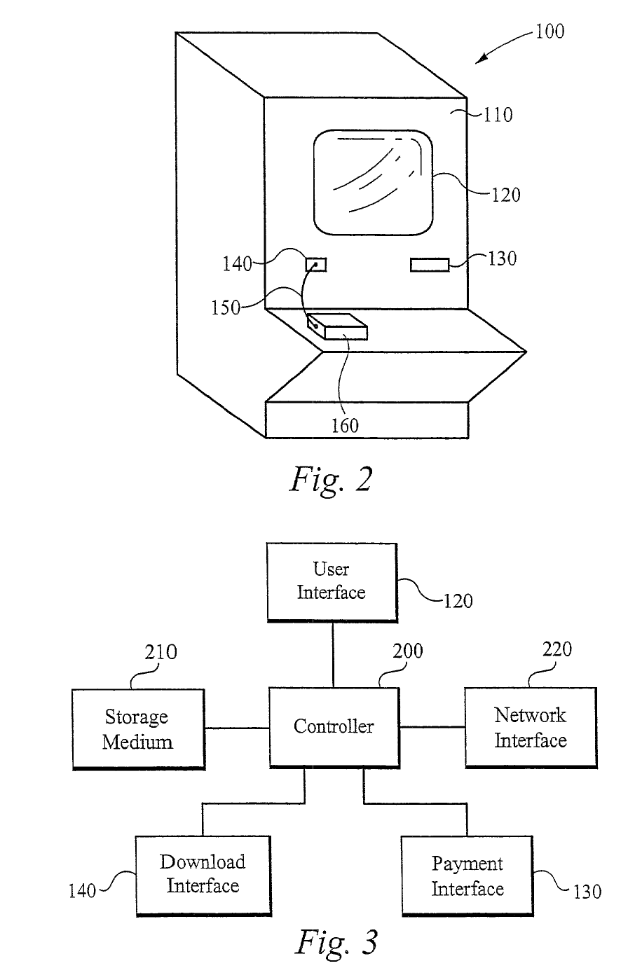

FIG. 2 illustrates a multimedia content vending machine 100 of the preferred embodiment of the present invention. The vending machine 100 includes a cabinet 110, a user interface 120, a payment interface 130, and a download interface 140. An external media storage device 160 is preferably coupled to the download interface 140 by a communications cable 150. The communications cable 150 is preferably an IEEE 1394-2000 cable, although the communications cable 150 can be any conventional communications cable capable of transmitting audio and visual data. Alternatively, the external media storage device 160 is coupled to the download interface 140 by any appropriate connection, including a wireless connection. The external media storage device 160 is preferably an audio/video hard disk drive (AVHDD) that communicates with the download interface 140 using the IEEE 1394-2000 standard. In the preferred embodiment of the present invention, a single external media storage device 160 is coupled to the vending machine 100 via the download interface 140. Alternatively, a plurality of external media storage devices can be coupled to the vending machine 100 for distributed recording.

FIG. 3 illustrates a block diagram of the internal components of the multimedia content vending machine 100 according to the preferred embodiment of the present invention. A controller 200 is coupled to a storage medium 210, a network interface 220, the user interface 120, the payment interface 130, and the download interface 140. The storage medium 210 stores a plurality of multimedia data files. The user interface 120 is preferably a touch screen to accept user input. Alternatively, the user interface 120 is a conventional display connected to a full size keyboard or a reduced size entry pad such as those commonly found at most automated teller machines. The user interface 120 displays a menu of downloadable selections that correspond to the plurality of multimedia data files stored in the storage medium 210. The user makes a selection by choosing one of the menu items displayed in the user interface 120. This selection is transmitted to the controller 200 for processing. The user interface 120 also provides additional features that enable the user to view a preview of one or more of the downloadable selections before making a selection. The multimedia content vending machine 100 preferably provides downloadable content available on a rental basis. The user interface 120 displays various rental terms, for example how much it costs to rent a selection for a specified number of days, and prompts the user to select a rental option. Although rental is the preferred method of providing multimedia content, purchase options can also be included. Once a downloadable selection is made and the rental terms specified, the user interface 120 prompts the user for the desired payment method. The payment interface 130 is preferably a credit card reader capable of accepting credit cards or debit cards. Additionally, the payment interface 130 can include a money collector into which the user can deposit paper money or coins. The user interface 120 displays payment status and verification. Once payment is authorized by the payment interface 130, the payment interface 130 notifies the controller 200 that payment is authorized. As an alternative means for payment, the external media storage device 160 includes billing information related to the user, for example credit card billing information, whereby the controller 200 reads this billing information to obtain payment authorization.

Once the controller 200 receives payment notification, the controller 200 instructs the storage medium 210 to transmit the multimedia data file corresponding to the user selection to the download interface 140. The multimedia data file is preferably sent from the storage medium 210 to the download interface 140 over an IEEE 1394-2000 serial bus. Alternatively, any conventional system bus, cable or wireless connection, capable of transmitting digital data is sufficient, as described above. The download interface 140 preferably includes an IEEE 1394-2000 serial bus interface circuit for receiving the transmitted multimedia data file from the storage medium 210 and for transmitting the multimedia data file to the external media storage device 160 via the communications cable 150. The user provides the external media storage device 160. At any point prior to downloading the selected multimedia data file, the user is to connect the external media storage device 160 to the communications cable 140.

Preferably, the storage medium 210 includes a plurality of media storage devices for storing the plurality of multimedia data files. Preferably, each of the media storage devices is an AVHDD similar in type to the AVHDD used as the external media storage device 160. It should be clear to those skilled in the art that the storage medium 210 can also be a single AVHDD, or any one or more optical, magnetic, or opto-magnetic storage devices capable of storing digital data.

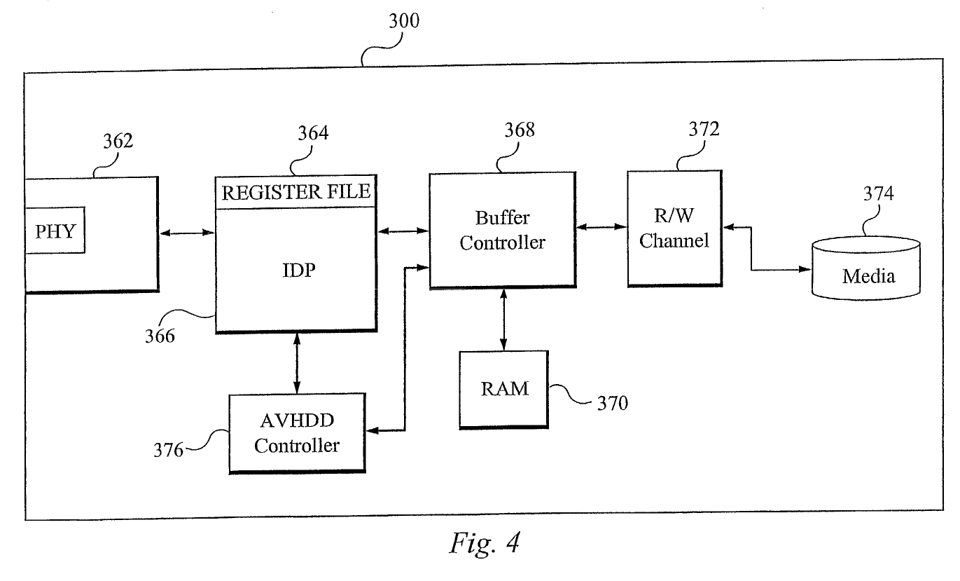

FIG. 4 illustrates a block diagram of the preferred embodiment of a hardware system resident in an AVHDD 300 used as either the storage medium 210 or the external media storage device 160. The AVHDD 300 includes a system interface 362 for sending communications to and receiving communications from the controller 200, the network interface 220, and the download interface 140. The system interface 362 is coupled to an embedded filter 366. Preferably, the system interface 362 includes an IEEE 1394-2000 serial bus interface circuit and the embedded filter 366 is an isochronous data pipe, as will be discussed below. The embedded filter 366 is coupled to a buffer controller 368. The buffer controller 368 is also coupled to a RAM 370 and to a read/write channel circuit 372. The read/write channel circuit 372 is coupled to media 374 on which data is stored within the AVHDD 300. The read/write channel circuit 372 controls the storage operations on the media 374, including reading data from the media 374 and writing data to the media 374. An AVHDD controller 376 is coupled to the embedded filter 366 for controlling the manipulation of data streams and to the buffer controller 368 for controlling read and write operations to the media 374.

During a write operation to the AVHDD 300, the system interface 362 receives a stream of data from the network interface 220. The system interface 362 then forwards this data to the embedded filter 366. The embedded filter 366 modifies the data as specified by the programmed instructions from the AVHDD controller 376, and forwards the modified data to the buffer controller 368. Data modification includes, but is not limited to, decryption, encryption, and reformatting. The buffer controller 368 then stores this modified data temporarily in a buffer in the RAM 370. When the read/write channel circuit 372 is available, the buffer controller 368 reads the data from the RAM 370 and forwards it to the read/write channel circuit 372. The read/write channel circuit 372 then writes the data onto the media 374. Because the embedded filter 366 is programmable, the data can be manipulated during a write operation, during a read operation or during both write and read operations.

During a read operation from the AVHDD 300, a stream of data is read from the media 374 by the read/write channel circuit 372. The read operation is only performed after the AVHDD controller 376 receives read instructions from the controller 200, as discussed above. This stream of data is forwarded by the read/write channel circuit 372 to the buffer controller 368. The buffer controller 368 then stores this data temporarily in a circular buffer in the RAM 370. When the system interface 362 is available, the buffer controller 368 reads the data from the RAM 370 and forwards it to the embedded filter 366. If the embedded filter 366 is programmed to manipulate the data stream during a read operation, this manipulation is performed and the data is forwarded to the system interface 362. In the preferred embodiment, the IEEE 1394-2000 serial bus interface circuit within the system interface 362 then formats the data according to the requirements of the IEEE 1394-2000 standard and transmits this data to the download interface 140.

The embedded filter 366 is preferably programmed by the AVHDD controller 376 to manipulate streams of data received by or to be transmitted from the AVHDD 300. As described above, the embedded filter 366 is preferably an isochronous data pipe. The isochronous data pipe 366 is programmable and will execute a series of instructions on a stream of data in order to perform manipulations on the data as required for decrypting, encrypting, and appropriate formatting. The isochronous data pipe 366 call be programmed to manipulate both asynchronous and isochronous data. A register file 364 is programmed by the AVHDD controller 376 and used to manipulate the data flowing through the isochronous data pipe 366, as necessary.

In the preferred embodiment, the storage medium 210 comprises a plurality of AVHDDs 300. The plurality of multimedia data files stored in the plurality of AVHDDs of the storage medium 210 are preferably encrypted using 5C copy protection, although alternatively any method of encryption to prevent unauthorized copying can be used. While it is preferred that the storage medium 210 comprises a plurality of AVHDDs, the storage medium 210 can alternatively be comprised of DVDs or any other form of high capacity optical storage, as long as the alternative storage means are capable of enforcing copy protection requirements and enforcing an expiration time process which will be discussed below.

A transaction is established between the user and the vending machine 100 once the user selects a multimedia data file for download, specifies the rental terms, and provides authorized payment. Based upon the transaction, the vending machine 100 is to provide the selected multimedia data file to the external media storage device 160 where the multimedia data file is available to be viewed for a predetermined time frame. The controller 200 determines the predetermined time frame as an expiration time. As such, the external media storage device 160 must support an expiration time process for validating data, which will be described below. The expiration time is determined based on the rental terms selected.

To download the selected multimedia data file, a communications path is established between an internal AVHDD within the storage medium 210 and the external media storage device 160 via the download interface 140. The selected multimedia data file can also be downloaded through the network interface 220, as discussed below. The internal AVHDD is the AVHDD where the selected multimedia data file is stored. The controller 200 transmits the expiration time to the internal AVHDD. The internal AVHDD encrypts the expiration time and transmits the encrypted expiration time and the already encrypted multimedia data file, along with the key(s) to decrypting them both, to the external media storage device 160 over the established communications path. During download of the multimedia data file to the external media storage device 160, if the external media storage device 160 is disconnected from the vending machine 100 before the download is complete, then the external media storage device 160 automatically deletes the portion of the downloaded multimedia data file that has already been received. In this manner, no partial multimedia data files are stored. Once downloaded onto the external media storage device 160, the multimedia data file is managed by the external media device 160.

To playback the downloaded multimedia data file, the user connects the external media storage device 160 to a home network capable of interfacing with the external media storage device 160. Preferably, the home network includes a television, or other display device, coupled to an IEEE 1394-2000 serial bus network. As discussed above, the external media storage device 160 is preferably all external AVHDD. Before playback, the external AVHDD decrypts the expiration time and determines if the downloaded multimedia data file remains valid based on the expiration time. If the multimedia data file is valid, the external AVHDD decrypts the encrypted multimedia data file and transmits the decrypted multimedia data file to the television for display. A preferred method of validating the downloaded multimedia data file is taught in U.S. patent application Ser. No. 09/920,660, filed on Aug. 1, 2001, and entitled “AN APPARATUS FOR AND METHOD OF INVALIDATING DATA OR DELETING DIGITAL CONTENT AFTER IT EXPIRES BY COMPARING THE EMBEDDED TIME WITH A GLOBAL TIME”, which is hereby incorporated by reference.

The preferred method of validating the downloaded multimedia data file compares the encrypted expiration time to a current time obtained from a secure clock. The secure clock is provided by any conventional timing means that is coupled to the external AVHDD or to the home network on which the external AVHDD resides. The secure clock is different than a local clock, for example a PC-based clock. With a local clock, the user can locally alter the time. Providing means for the user to alter the current time is not desirable. A preferred method of obtaining a current time from a secure clock is taught in U.S. patent applicationi Ser. No. ______, filed on ______, and entitled “______”, which is hereby incorporated by reference. The external AVHDD decrypts the encrypted expiration time of the downloaded multimedia data file and determines if the expiration time is equal to or greater than the current time obtained from the secure clock. If the expiration time is earlier than the current time, then the digital content remains valid and the multimedia data file is decrypted for playback. If the expiration time is equal to or later than the current time, then the multimedia data file is invalidated. It should be noted that the multimedia data file can also be deleted from the external AVHDD although most conventional hard disk drives do not actually erase data. Instead, hard disk drives disable their ability to access the data, thereby invalidating the data. In which case, the invalidated data physically remains on the hard disk drive until it is written over. In this manner, the external AVHDD autonomously invalidates and deletes expired multimedia data files.

Referring back to FIG. 3, the network interface 220 is used to couple the vending machine 100 to an external communications network. Preferably, the communications network is the Internet. Alternatively, the communications network is a dedicated data network or any conventional network capable of transmitting data. In the case where the payment interface 130 processes a credit card or a debit card transaction, request and receipt of payment authorization is communicated over the communications network via the network interface 220. Preferably, the payment interface 130 sends the payment authorization request to the network interface 220 and the network interface 220 transmits the request over the communications network. When payment authorization is received, the network interface 220 forwards the payment authorization to the payment interface 130. Alternatively, the controller 200 acts as intermediary between the payment interface 130 and the network interface 220. In this alternate embodiment, the payment interface 130 send the payment authorization request to the controller 200, the controller 200 then forwards the request to the network interface 220, and the network interface 220 transmits the request over the communications network. When payment authorization is received, the network interface 220 forwards the payment authorization to the controller 200, and the controller 200 then forwards the payment authorization to the payment interface 130.

One or more of the multimedia data files stored in the storage medium 210 can be replaced by new multimedia data files downloaded over the communications network via the network interface 220. Further, one or more menu items listed as selectable multimedia data files available for download can refer to multimedia data files not located locally on the storage medium 210. Instead, these one or more menu items refer to multimedia data items available for download from a remote location to the vending machine 100 where the remotely located multimedia data files are downloaded over the communications network to the external media storage device 160 via the vending machine 100. Alternatively, the vending machine 100 acts as a processing center without a local storage medium 210. In this alternative embodiment, the vending machine 100 obtains the user selection, obtains payment authorization, and provides the interface for the external media storage device 160. The selected multimedia data file is downloaded to the external media storage device 160 from a remote location via the vending machine 100. In this alternate embodiment, the network interface 220 provides a broadband connection to the communications network in order to download the selected multimedia data file within a reasonable time frame for a positive user experience.

In operation, a user interfaces with the vending machine using the user interface. Preferably, the user interface is a touch screen. The user browses a list of available multimedia data files, selects a multimedia data file, and chooses a rental option. The user is prompted to make payment using the payment interface. Preferably, the payment interface is a credit card reader. Payment Authorization is made and verification is displayed to the user on the touch screen. The user is prompted to connect their external media storage device to the vending machine at the download interface. Preferably, the external media storage device is an AVHDD. The selected multimedia data file is then downloaded from the internal storage medium to the AVHDD. Preferably, the internal storage medium is a plurality of AVHDDs. Alternatively, the vending machine is coupled to a remote storage location via a communications network and the selected multimedia data file is downloaded from the remote storage location to the vending machine and finally to the external storage device of the user. The selected multimedia data file is preferably encrypted and downloaded along with an encrypted expiration time corresponding to the length of the rental term selected. To playback the downloaded multimedia data file, the AVHDD decrypts the expiration time and compares the expiration time to a current time. The current time is obtained from a secure clock source. If the expiration time is earlier than the current time, then the multimedia data file is still valid and the AVHDD decrypts and transmits the multimedia data file to a display device. If the expiration time is equal to or later than the current time, then the multimedia data file is no longer valid and the AVHDD invalidates or deletes the multimedia data file. In this manner, a user can download a multimedia data file from the vending machine and have playback access to the multimedia data file for a predetermined period of time. After the predetermined period of time, the downloaded multimedia data file can no longer be decrypted for playback.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is used with an IEEE 1394-2000 serial bus structure, the present invention could also be implemented on any other appropriate system bus structures. Additionally, it will also be apparent that while the preferred embodiment of the present invention includes AVHDDs within the digital content vending machine, any other appropriate media storage device can also be used.

I claim:

1. A multimedia content vending machine comprising:
a. a processor;
b. a storage medium to store a plurality of multimedia data files;
c. a user interface to display a menu of downloadable selections corresponding to the plurality of multimedia data files stored in the storage medium, identify a user selection from the menu, and notify the processor of the user selection;
d. a payment interface to accept payment and notify the processor when payment is made; and
e. a download interface configured to couple to an external media storage device,
wherein the processor instructs the storage medium to transmit the stored multimedia data file corresponding to the user selection upon receiving payment notification from the payment interface, and further wherein the download interface receives the transmitted multimedia data file from the storage medium and transmits the multimedia data file to the external media storage device.

2. The multimedia content vending machine according to claim 1, further comprising a network interface configured to couple to a communications network.

3. The multimedia content vending machine according to claim 2, wherein the payment interface is a credit card reader to read credit cards and receive payment authorization associated with the read credit card.

4. The multimedia content vending machine according to claim 3, wherein the credit card reader also accepts debit cards.

5. The multimedia content vending machine according to claim 3, wherein credit card payment authorization is obtained via communication over the communications network.

6. The multimedia content vending machine according to claim 2, wherein one or more of the plurality of stored multimedia data files are replaced by multimedia data files downloaded from the communications network via the network interface.

7. The multimedia content vending machine according to claim 6, wherein the communications network is a selective one of a public switched telephone network and a dedicated data network.

8. The multimedia content vending machine according to claim 1, wherein the user interface is a monitor including a touch screen to receive user input.

9. The multimedia content vending machine according to claim 1, wherein the download interface includes an interface circuit that substantially complies with an IEEE 1394-2000 standard.

10. The multimedia content vending machine according to claim 9, wherein the multimedia data file is transmitted from the download interface to the external media storage device over a serial bus that substantially complies with the IEEE 1394-2000 standard.

11. The multimedia content vending machine according to claim 10, wherein the stored multimedia data file is transmitted from the storage medium to the download interface over a serial bus that substantially complies with the IEEE 1394-2000 standard.

12. The multimedia content vending machine according to claim 1, wherein the storage medium includes a plurality of media storage devices.

13. The multimedia content vending machine according to claim 12, wherein one or more of the plurality of media storage devices are replaced in order to change the multimedia data files available for downloadable selection.

14. The multimedia content vending machine according to claim 1, wherein the plurality of multimedia data files stored in the storage medium are encrypted.

15. The multimedia content vending machine according to claim 14, wherein the multimedia data file received by the external media storage device is encrypted and the external media storage device decrypts the multimedia data file for playback.

16. The multimedia content vending machine according to claim 15, wherein the downloaded encrypted multimedia data file includes a time restriction that limits playback of the multimedia data file by the external media storage device to a specified time frame.

17. A multimedia content vending machine comprising:
a. a processor;
b. a user interface for displaying a menu of downloadable selections corresponding to a plurality of multimedia data files stored at a remote location, identifying a user selection from the menu, and notifying the processor of the user selection;
c. a payment interface for accepting payment and for notifying the processor when payment is made;
d. a download interface for coupling with an external media storage device; and
e. a network interface for coupling with a communications network, wherein the remote location storing the plurality of multimedia data files is coupled to the network interface via the communications network,
wherein upon receiving payment notification from the payment interface, the processor instructs the remote location to transmit the stored multimedia data file corresponding to the user selection, the network interface receives the transmitted multimedia data file and transmits the multimedia data file to the download interface, and the download interface receives the transmitted multimedia data file from the network interface and transmits the multimedia data file to the external media storage device.

18. The multimedia content vending machine according to claim 17, wherein the payment interface is a credit card reader for reading credit cards and receiving payment authorization associated with the read credit card.

19. The multimedia content vending machine according to claim 18, wherein the credit card reader also accepts debit cards.

20. The multimedia content vending machine according to claim 18, wherein credit card payment authorization is obtained via communication over the communications network.

21. The multimedia content vending machine according to claim 18, wherein the communications network is a selective one of a public switched telephone network or a dedicated data network.

22. The multimedia content vending machine according to claim 17, wherein the user interface is a monitor including a touch screen for receiving user input.

23. The multimedia content vending machine according to claim 17, wherein the download interface includes an interface circuit that substantially complies with an IEEE 1394-2000 standard.

24. The multimedia content vending machine according to claim 17, wherein the multimedia data file is transmitted from the download interface to the external media storage device over a serial bus that substantially complies with the IEEE 1394-2000 standard.

25. The multimedia content vending machine according to claim 17, wherein the multimedia data file received by the external media storage device is encrypted and the external media storage device decrypts the multimedia data file for playback.

26. The multimedia content vending machine according to claim 25, wherein the downloaded encrypted multimedia data file includes a time restriction that limits playback of the multimedia data file by the external media storage device to a specified time frame.

27. A multimedia content vending machine comprising:
a. a processor;
b. a storage medium for storing a plurality of encrypted multimedia data files;
c. a user interface for displaying a menu of downloadable selections corresponding to the plurality of multimedia data files stored in the storage medium, identifying a user selection from the menu, and notifying the processor of the user selection;
d. a payment interface for accepting payment and for notifying the processor when payment is made; and
e. a download interface for coupling with an external media storage device,
wherein upon receiving payment notification from the payment interface, the processor instructs the storage medium to further encrypt the stored multimedia data file corresponding to the user selection with a time key for restricting playback to within a predetermined time frame and to transmit the encrypted multimedia data file to the download interface, and the download interface receives the transmitted encrypted multimedia data file from the storage medium and transmits the encrypted multimedia data file to the external media storage device.

28. The multimedia content vending machine according to claim 27, further comprising a network interface for coupling with a communications network.

29. The multimedia content vending machine according to claim 28, wherein the payment interface is a credit card reader for reading credit cards and receiving payment authorization associated with the read credit card.

30. The multimedia content vending machine according to claim 29, wherein the credit card reader also accepts debit cards.

31. The multimedia content vending machine according to claim 29, wherein credit card payment authorization is obtained via communication over the communications network.

32. The multimedia content vending machine according to claim 28, one or more of the plurality of stored multimedia data files are replaced by multimedia data files downloaded from the communications network via the network interface.

33. The multimedia content vending machine according to claim 32, wherein the communications network is a selective one of a public switched telephone network or a dedicated data network.

34. The multimedia content vending machine according to claim 27, wherein the user interface is a monitor including a touch screen for receiving user input.

35. The multimedia content vending machine according to claim 27, wherein the download interface includes an interface circuit that substantially complies with an IEEE 1394-2000 standard.

36. The multimedia content vending machine according to claim 35, wherein the multimedia data file is transmitted from the download interface to the external media storage device over a serial bus that substantially complies with the IEEE 1394-2000 standard.

37. The multimedia content vending machine according to claim 36, wherein the stored multimedia data file is transmitted from the storage medium to the download interface over a serial bus that substantially complies with the IEEE 1394-2000 standard.

38. The multimedia content vending machine according to claim 27, wherein the storage medium includes a plurality of media storage devices.

39. The multimedia content vending machine according to claim 38, wherein one or more of the plurality of media storage devices are replaced in order to change the multimedia data files available for downloadable selection.

40. A multimedia content vending system comprising:
a. a media storage device for storing multimedia content; and
b. a multimedia content vending machine including a processor, a storage medium for storing a plurality of multimedia data files, a user interface for displaying a menu of downloadable selections corresponding to the plurality of multimedia data files stored in the storage medium, identifying a user selection from the menu, and notifying the processor of the user selection, a payment interface for accepting payment and for notifying the processor when payment is made, and a download interface for coupling with the media storage device, wherein upon receiving payment notification from the payment interface, the processor instructs the storage medium to transmit the stored multimedia data file corresponding to the user selection to the download interface, and the download interface receives the transmitted multimedia data file from the storage medium and transmits the multimedia data file to the media storage device.

41. The multimedia content vending system according to claim 40, further comprising a network interface for coupling with a communications network.

42. The multimedia content vending system according to claim 41, wherein the payment interface is a credit card reader for reading credit cards and receiving payment authorization associated with the read credit card.

43. The multimedia content vending system according to claim 42, wherein the credit card reader also accepts debit cards.

44. The multimedia content vending system according to claim 42, wherein credit card payment authorization is obtained via communication over the communications network.

45. The multimedia content vending system according to claim 41, one or more of the plurality of stored multimedia data files are replaced by multimedia data files downloaded from the communications network via the network interface.

46. The multimedia content vending system according to claim 45, wherein the communications network is a selective one of a public switched telephone network or a dedicated data network.

47. The multimedia content vending system according to claim 40, wherein the user interface is a monitor including a touch screen for receiving user input.

48. The multimedia content vending system according to claim 40, wherein the download interface includes an interface circuit that substantially complies with an IEEE 1394-2000 standard.

49. The multimedia content vending system according to claim 48, wherein the multimedia data file is transmitted from the download interface to the external media storage device over a serial bus that substantially complies with the IEEE 1394-2000 standard.

50. The multimedia content vending system according to claim 49, wherein the stored multimedia data file is transmitted from the storage medium to the download interface over a serial bus that substantially complies with the IEEE 1394-2000 standard.

51. The multimedia content vending system according to claim 40, wherein the storage medium includes a plurality of media storage devices.

52. The multimedia content vending system according to claim 51, wherein one or more of the plurality of media storage devices are replaced in order to change the multimedia data files available for downloadable selection.

53. The multimedia content vending system according to claim 40, wherein the plurality of multimedia data files stored in the storage medium are encrypted.

54. The multimedia content vending system according to claim 53, wherein the multimedia data file received by the external media storage device is encrypted and the external media storage device decrypts the multimedia data file for playback.

55. The multimedia content vending system according to claim 54, wherein the downloaded encrypted multimedia data file includes a time restriction that limits playback of the multimedia data file by the external media storage device to a specified time frame.

56. A multimedia content vending machine comprising:
a. means for controlling;
b. means for storing a plurality of multimedia data files;
c. means for interfacing with a user wherein the means for interfacing with a user displays a menu of downloadable selections corresponding to the plurality of multimedia data files stored in the means for storing, identifies a user selection from the menu, and notifies the means for controlling of the user selection;
d. means for accepting payment and for notifying the means for controlling when payment is made; and
e. a first means for interfacing with a network coupled to an external media storage device,
wherein the means for controlling instructs the means for storing to transmit the stored multimedia data file corresponding to the user selection upon receiving payment notification from the means for accepting payment, and further wherein the first means for interfacing with the network receives the transmitted multimedia data file from the means for storing and transmits the multimedia data file to the external media storage device.

57. The multimedia content vending machine according to claim 56, further comprising a second means for interfacing with a network coupled with a communications network.

58. The multimedia content vending machine according to claim 57, wherein the means for a payment is a credit card reader for reading credit cards and receiving payment authorization associated with the read credit card.

59. The multimedia content vending machine according to claim 58, wherein the credit card reader also accepts debit cards.

60. The multimedia content vending machine according to claim 58, wherein credit card payment authorization is obtained via communication over the communications network.

61. The multimedia content vending machine according to claim 57, wherein one or more of the plurality of stored multimedia data files are replaced by multimedia data files downloaded from the communications network via the second means for interfacing with a network.

62. The multimedia content vending machine according to claim 61, wherein the communications network is a selective one of a public switched telephone network and a dedicated data network.

63. The multimedia content vending machine according to claim 56, wherein the means for interfacing with a user is a monitor including a touch screen for receiving user input.

64. The multimedia content vending machine according to claim 56, wherein the first means for interfacing with a network includes an interface circuit that substantially complies with an IEEE 1394-2000 standard.

65. The multimedia content vending machine according to claim 64, wherein the multimedia data file is transmitted from the first means for interfacing with a network to the external media storage device over a serial bus that substantially complies with the IEEE 1394-2000 standard.

66. The multimedia content vending machine according to claim 65, wherein the stored multimedia data file is transmitted from the means for storage to the first means for interfacing with a network over a serial bus that substantially complies with the IEEE 1394-2000 standard.

67. The multimedia content vending machine according to claim 56, wherein the means for storing includes a plurality of media storage devices.

68. The multimedia content vending machine according to claim 67, wherein one or more of the plurality of media storage devices are replaced in order to change the multimedia data files available for downloadable selection.

69. The multimedia content vending machine according to claim 56, wherein the plurality of multimedia data files stored in the storage medium are encrypted.

70. The multimedia content vending machine according to claim 69, wherein the multimedia data file received by the external media storage device is encrypted and the external media storage device decrypts the multimedia data file for playback.

71. The multimedia content vending machine according to claim 70, wherein the downloaded encrypted multimedia data file includes a time restriction that limits playback of the multimedia data file by the external media storage device to a specified time frame.

72. A method of distributing digital content comprising:
a. storing a plurality of multimedia data files in a physically accessible multimedia content vending machine;
b. displaying a menu of downloadable selections on the multimedia content vending machine, wherein the menu of downloadable selections corresponds to the plurality of multimedia data files;
c. identifying a user selection from the menu;
d. notifying a processor of the user selection;
e. accepting payment and notifying the processor when payment is made; and
f. transmitting the stored multimedia data file corresponding to the user selection upon receiving payment notification at the processor, wherein the multimedia data file is transmitted from the multimedia content vending machine to an externally coupled media storage device.

73. The method according to claim 72 further comprising establishing a communication path between the multimedia content vending machine and a remote location.

74. The method according to claim 73 further comprising replacing one of the plurality of multimedia data files stored on the multimedia content vending machine with a multimedia data file stored at the remote location, wherein the multimedia data file stored at the remote location is downloaded from the remote location to the multimedia content vending machine over the communication path.

75. The method according to claim 72 further comprising encrypting the transmitted multimedia data file with a time restriction that limits playback of the multimedia data file by the media storage device to a specified time frame.

76. A method of distributing digital content comprising:
a. storing a plurality of multimedia data files at a remote location;
b. displaying a menu of downloadable selections at a multimedia content vending machine, wherein the menu of downloadable selections corresponds to the plurality of multimedia data files;
c. identifying a user selection from the menu;
d. notifying a processor within the multimedia content vending machine of the user selection;
e. accepting payment and notifying the processor when payment is made; and
f. transmitting the stored multimedia data file corresponding to the user selection upon receiving payment notification at the processor, wherein the multimedia data file is transmitted from the remote location over a communications path to the multimedia content vending machine and to an externally coupled media storage device.

77. The method according to claim 76 further comprising encrypting the transmitted multimedia data file with a time restriction that limits playback of the multimedia data file by the media storage device to a specified time frame.

78. A method of accessing digital content comprising:
a. making a selection from a menu of downloadable selections displayed on a multimedia content vending machine, wherein the menu of downloadable selections corresponds to a plurality of multimedia data files stored within the multimedia content vending machine;
b. providing payment through a payment interface on the multimedia content vending machine;
c. connecting an external media storage device to the multimedia content vending machine;
d. downloading the multimedia data file corresponding to the selection onto the external media storage device; and
e. disconnecting the external media storage device from the multimedia content vending machine;

79. The method according to claim 78 further comprising selecting a rental term prior to providing payment, wherein the rental term defines a time restriction that limits playback of the multimedia data file by the external media storage device to a specified time frame.

80. The method according to claim 79 further comprising encrypting the transmitted multimedia data file with the time restriction.

81. A method of accessing digital content comprising:
a. making a selection from a menu of downloadable selections displayed on a multimedia content vending machine, wherein the menu of downloadable selections corresponds to a plurality of multimedia data files stored at a remote location from the multimedia content vending machine;
b. providing payment through a payment interface on the multimedia content vending machine;
c. connecting an external media storage device to the multimedia content vending machine;
d. downloading the multimedia data file corresponding to the selection from the a remote location over a communications path to the multimedia content vending machine and onto the external media storage device; and
e. disconnecting the external media storage device from the multimedia content vending machine;

82. The method according to claim 81 further comprising selecting a rental term prior to providing payment, wherein the rental term defines a time restriction that limits playback of the multimedia data file by the external media storage device to a specified time frame.

83. The method according to claim 82 further comprising encrypting the transmitted multimedia data file with the time restriction.
